(19) United States
(12) Patent Application Publication
(10) Pub. No.: US 2024/0223500 A1
(43) Pub. Date: Jul. 4, 2024

(54) PERIPHERAL COMPONENT INTERCONNECT EXPRESS OVER FABRIC NETWORKS

(71) Applicant: SK Hynix NAND Product Solutions Corp. (dba Solidigm), San Jose, CA (US)

(72) Inventor: George Kalwitz, Mead, CO (US)

(21) Appl. No.: 18/089,870

(22) Filed: Dec. 28, 2022

(51) Int. Cl. H04L 45/74; G06F 13/42; H04L 12/40; H04L 49/25

(52) U.S. Cl. CPC H04L 45/74; G06F 13/4221; H04L 12/40; H04L 49/25; G06F 2213/0026; H04L 2212/00

(57) ABSTRACT

Systems and related methods for stateless communication of information between devices over fabric networks, including processing circuitry, are described. The information may be received from a first device in the form of a plurality of packets and be addressed to a second device of a plurality of devices using a device identifier, such as a bus:device:function (BDF) identifier. The processing circuitry maps the device identifier of the second device to a unique device address. The processing circuitry encapsulates each of the plurality of packets to generate a plurality of encapsulated packets. The processing circuitry communicates each of the plurality of encapsulated packets over the fabric network. The unique device address of the second device is used to route the plurality of encapsulated packets to the second device.

### TECHNICAL FIELD

The present disclosure is related to computer systems, storage device systems, and methods for communicating over a fabric network, and more specifically to using identifiers, such as bus:device:function identifiers, to statelessly communicate over any type of fabric network.

### SUMMARY

Disaggregated and composable systems facilitate the sharing of distributed resources. Traditional systems are often configured with dedicated resources that are sized for worst-case conditions, which increases space, cost, power, and cooling requirements for each system. Sharing resources can be advantageous given a fast, efficient, and scalable fabric or fabric network, and associated communications architecture over the fabric. A stateless fabric communication architecture is more scalable than a stateful fabric communication architecture because the dedicated resources are needed to manage stateful communications. Thus, if a system having a stateful fabric communication architecture increases in size, additional dedicated resources are needed to manage the increased stateful communications.

As devices such as central processing units (CPUs), data processing units (DPUs), graphics cards and graphics processing units (GPUs), field-programmable gate arrays (FPGAs), application-specific integrated circuits (ASICs), and solid-state drives (SSDs) improve, sending and receiving information between different devices may be a limiting factor in system performance. For example, a first and second device may be able to process information faster than the information can be sent and received between the devices. So, a faster communication architecture or protocol may be desired. Other applications, such as cloud computing, real-time analytics, and artificial intelligence, may use devices in different physical locations, such as two different cities. The distance between the devices may limit approaches to increase speed or bandwidth to send and receive information.

In one approach, peripheral component interconnect express (PCIe) may be used as a high-speed standard bus interface for communication between a CPU and other devices (referred to as devices in communication), such as sound cards, video cards, Ethernet cards, redundant array of inexpensive disks (RAID) cards, and solid-state drives (SSDs). Each of device is assigned a device identifier, such as a bus:device:function (BDF) identifier, and communicates using the device identifier. Per the PCIe 4.0 standard, PCIe may allow devices in communication with another to transfer information at a bandwidth up to a 32 GB/s. But, PCIe as a transport does not define a protocol to govern communication between the CPU and devices in a separate system. PCIe is used internal to a system, usually a computer of a data center, and may not be used for devices external to the system (e.g., outside of the computer of the data center).

In another approach, a non-volatile memory express (NVMe) communication protocol may be used to transfer information between devices, and in particular, between a host CPU and a PCIe attached storage system such as a solid-state drive (SSD). Thus, the NVMe protocol is designed for communication with storage devices directly attached to a local and dedicated PCIe bus. The NVMe protocol is designed for local use over a computer's PCIe bus for high-speed data transfer between the host device and the storage system. The host device and storage system are bound to input/output (I/O) queues, which are used to manage the transfer of information. The I/O queues are placed in the host device's memory, which may reduce a cost and complexity of the storage system. But, NVMe has limitations. The I/O queues may reduce memory available for the host device to perform other operations. Since the I/O queues are located in the host device's memory, the storage system may not be bound to or communicate with another host device. The NVMe protocol is not designed to be used in multi-host environments, nor for a fabric connection between the host device and the storage subsystem. For example, the NVMe protocol is not designed to govern communication between a CPU in a first city and an SSD in a second city because the SSD may need to directly connect to the CPU through a motherboard connection (e.g., a slot or expansion slot) without cables. The SSD may also connect to the CPU using a PCIe cable, but PCIe cables may require short lengths (e.g., 15, 12, or 8 inches) to achieve high-speed communication.

In another approach, PCIe may be used as a fabric network for communication between the host device and the storage system. The PCIe fabric may extend PCIe beyond a computer of the data center to facilitate communications within a rack or across the data center. But, PCIe as a fabric does not provide a method for communication between different host devices (e.g., CPU-to-CPU communications), nor a method to share devices across a native PCIe fabric network. The PCIe fabric does not define I/O queues like NVMe.

In another approach, NVMe over Fabrics (NVMeoF) may be used in conjunction with PCIe busses to communicate between the host device and the storage system over a fabric network. The fabric network allows the devices to be located in different locations and may include traditional fabrics such as Ethernet, Fibre Channel, and Infiniband. Since NVMeoF uses NVMe, the host device and storage system are bound to I/O queues as described above. The I/O queues are placed in a controller of the storage system and not in the host device, which requires the storage system's drives (e.g., SSDs) to have a controller and memory available to manage the transfer of information. But, NVMeoF has limitations. Since NVMeoF is defined for use across the traditional fabrics, a protocol conversion from PCIe/NVMe to the traditional fabric is required. The protocol conversion typically requires a store-and-forward approach to moving information, such as data, of the NVMeoF exchange. As such, NVMeoF has problems scaling in some devices, such as storage bridges and just a bunch of flashes (JBOFs), which include an array of SSDs. The scaling problems arise from a need for a stateful system to track the progress of NVMeoF exchanges, and the need to store-and-forward the data associated with those exchanges at a small computer system interface (SCSI) exchange level. Information communicated between the host device and storage system may be received and assembled into a staging buffer. Performance may be reduced by the staging buffer. Scalability is limited by the CPU bandwidth needed to manage the stateful exchanges, including staging buffers, and by the memory space needed to hold the data because this level of store-and-forward imposes bottlenecks in larger systems, requiring more CPU power and buffer memory. These problems are most notable in the traditional fabrics largely due to the protocol conversion between PCIe and those traditional fabrics. The PCIe fabric may be used and may not be hindered by the same protocol conversion, but may be hindered by NVMeoF itself since NVMeoF was initially defined for the traditional fabric networks.

NVMeoF may use remote direct memory access (RDMA) to communicate between a memory of each device without using the CPU. The memory-to-memory communication may lower latency and increase response time. NVMeoF with RDMA may be easier for an initiator of a NVMe exchange since the initiator already has the data for the exchange in memory, and modem interface controllers, such as an Ethernet intelligent network interface controller (NIC) offload much of the stateful work. But, NVMeoF may be difficult for devices such as the storage bridge or the JBOF, which include many SSDs and connect to many initiators. The number of concurrent exchanges can be very large and are typically limited by available memory and CPU resources of the storage system controller. RDMA itself may be undesirable as it is not standard transmission control protocol (TCP)/internet protocol (IP). NVMeoF may also be encumbered by TCP/IP when used over the Ethernet fabric network. TCP/IP may require computing power of the storage system because a checksum may be calculated for each packet communicated. TCP/IP may impart more latency than other NVMeoF protocols since it may maintain and transmit multiple copies of data to bypass packet loss at a routing level. TCP/IP may import more latency than other NVMeoF protocols since it requires acknowledgement packets in response to information packets.

Accordingly, there is a need for high-speed communication architecture between devices connected to a fabric network that solve these problems and limitations. Such a solution uses a fabric network and leverages existing protocols and interfaces, such as PCIe, to statelessly communicate over existing fabric networks, such as Ethernet, Fibre Channel, and InfiniBand.

To solve these problems, systems and methods are provided herein for mapping a device identifier of devices to a unique address to communicate between the devices over the fabric network. The unique address may be a device address, such as a physical address or a fabric address.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system for communicating information between devices over a fabric network, in accordance with some embodiments of the present disclosure;

FIG. 2A shows an illustrative diagram of a system for communicating information between devices, including a subsystem of devices, over a fabric network, in accordance with some embodiments of the present disclosure;

FIG. 2B shows an illustrative diagram of a plurality of packets communicated between devices of FIG. 2A, in accordance with some embodiments of the present disclosure;

FIG. 3 shows an illustrative diagram of information communicated between devices using input/output (I/O) queues, in accordance with some embodiments of the present disclosure;

FIG. 4 shows an alternate illustrative diagram of information communicated between devices using I/O queues, in accordance with some embodiments of the present disclosure;

FIG. 5 illustrates a flowchart for communicating information over a fabric network, in accordance with some embodiments of this disclosure; and

FIG. 6 shows an example of system processing circuitry, in accordance with some embodiments of the present disclosure.

### DETAILED DESCRIPTION

In accordance with the present disclosure, systems and methods are provided to improve communication over fabric networks, and in particular, to provide stateless communication between devices over the fabric networks. In one approach, information may be received from a first device, such as by a processing circuitry. The information may be in the form of a plurality of packets, such as PCIe packets, and may be received through a peripheral component interconnect express (PCIe) bus interface. The received plurality of packets may be addressed to a second device using a device identifier of the second device. The device identifier is used to identify a specific device (e.g., the second device). The device identifier may be an enumerated identifier that is assigned based on querying connected devices, such as by sending a request to ask if a device is present on a slot of the processing circuitry and receiving an acknowledgement by a device that is connected to the slot. The device identifier may be assigned or hard-coded by a manufacturer or supplier of the device. The device identifier may be assigned based on a function of the device such that a single physical device may have a device identifier for each function it performs. Alternatively, the device may have a single device identifier for multiple functions and internally route information received to the appropriate function. The device identifier may be a slot identifier such that the device identifier is based on a slot the device is connected to. In some embodiments, the device identifier may be a bus:device:function (BDF) identifier, which is hereafter used as an example for discussion. However, it will be understood that other identifiers, such as the examples previously discussed, may be used. For example, in some embodiments, the device identifier is not limited to include components of bus, device, and function; the device identifier can be modified by, for example, having components rearranged, changed, added, and/or removed.

The first and second devices may be connected by a fabric network, such as Ethernet, Fibre Channel, or InfiniBand. The plurality of packets may be sent to the second device over the fabric network. Processing circuitry may encapsulate each packet of the plurality of packets before sending over the fabric network. The encapsulated packets may be decapsulated by the processing circuitry before sending to the second device, and the decapsulated packets may be sent using a PCIe bus interface. The encapsulated packets may be sent and received over the fabric network according to a particular protocol. The fabric protocol may require the information be sent to using a unique device address of the second device that is different than the BDF identifier. The BDF identifier may be mapped to the unique device address and the unique device address used to communicate the information through the network.

Each of the plurality of packets may be encapsulated and communicated over the fabric network using the unique device address of the second device. The plurality of packets may result in faster transfer speeds since entire transactions, such as small computer system interface (SCSI) transactions or non-volatile memory express (NVMe) transactions, do not need to be translated. The encapsulation requires no additional state information to link or associate the individual packets of the plurality of packets. Mapping the BDF identifier to the unique device address may allow the encapsulated packets to be communicated statelessly and flow between the first and second devices. Scalability is possible since CPU bandwidth is not needed from the first and second devices and memory space is not needed from the first and second devices and to hold the information. There are no stateful exchanges to manage an no store-and-forward to implement. The encapsulated packets flow between the devices without a staging buffer. A fabric protocol translation, such as RDMA over TCP/IP over Ethernet, is not needed.

In another approach, a first device may communicate with a plurality of second devices over a fabric network. The first device and each of the second devices may have a BDF identifier and may address information communicated to another using the BDF identifier. The BDF identifier may be converted to a unique device address according to the fabric network in order to send the information through the fabric network.

In another approach, I/O queues are placed in a memory of the processing circuitry. For example, the I/O queues may reside in a processing circuitry associated with the second device. Placing the I/O queues in the processing circuitry may free up memory of the first and second devices to handle other tasks. The I/O queues may allow multiple devices to connect to the second device.

The term “communicate” and variations thereof may include transfer of information, sending information, and receiving information, unless expressly specified otherwise.

The term “information” and variations thereof may include data, payload, headers, footers, metadata, PCIe transaction layer protocol packets (TLP), PCIe data link layer packets (DLLP), bits, bytes, and datagrams to name a few examples, unless expressly specified otherwise.

In some embodiments the system and methods of the present disclosure may refer to an SSD storage system, which may include an SSD pipelined accelerator and a storage controller, or a pipelined processor and network controller for transport layer protocols (e.g., PCIe).

An SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retains data without power and include a type of non-volatile storage technology. Quality of Service (QoS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

In some embodiments the system and methods of the present disclosure may refer to an HDD storage system, which may include an HDD controller and network controller for transport layer protocols (e.g., PCIe).

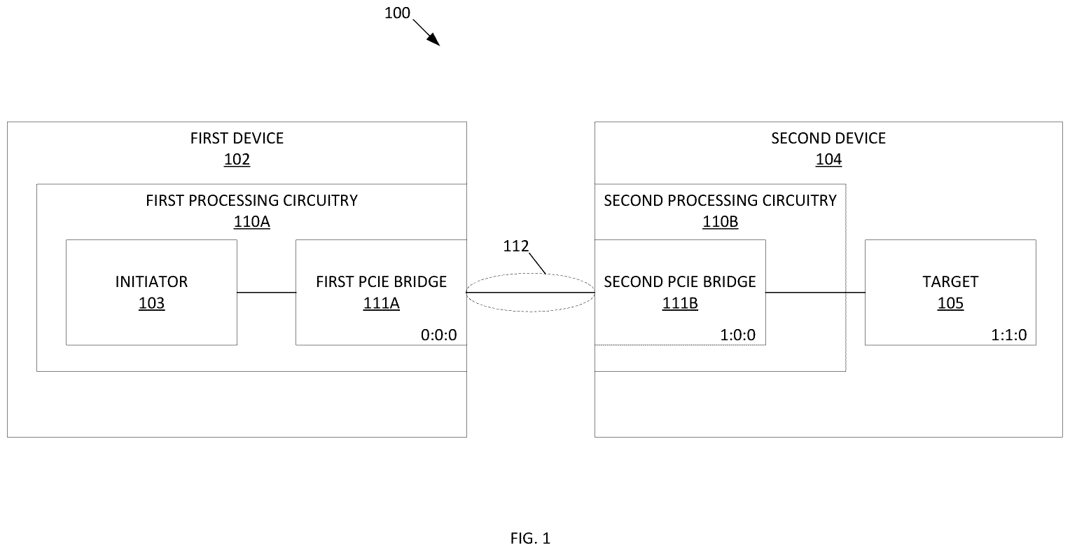

FIG. 1 shows an illustrative diagram of a system 100 for communicating information between devices over a fabric network 112, in accordance with some embodiments of the present disclosure. A first device 102 communicates with a second device 104.

The system 100 includes processing circuitry, such as a first processing circuitry 110A and a second processing circuitry 110B. The first processing circuitry 110A is part of the first device 102 and the second processing circuitry 110B is part of the second device 104. The first and second devices 102 and 104 communicate with another over the fabric network 112 through first and second processing circuitry 110A and 110B. In the depicted embodiment, the first processing circuitry 110A includes an initiator 103, such as a CPU, and a first PCIe bridge 111A. The second processing circuitry 110B includes a second PCIe bridge 111B. The first PCIe bridge 111A may receive information from the initiator 103 and communicate the information to the second PCIe bridge 111B. The information is addressed to a device identifier, such as a bus:device:function (BDF) identifier, of the second device 104, such as a target 105. The target 105 may be a memory or storage of the second device 104. The first processing circuitry 110A communicates the information to the second device 104 over the fabric network 112, which may be Ethernet, Fibre Channel (FC), or InfiniBand, to name a few examples. The first and/or second processing circuitry 110A and 110B maps the BDF identifier of the target 105 to a unique device address that is compatible with the fabric network 112. For example, if the fabric network 112 is an Ethernet network, the unique device address may be an internet protocol (IP) address.

The second processing circuitry 110B may similarly communicate information from the second device 104 to the first device 102 over the fabric network 112 using a BDF identifier of the first device 102, such as of the first PCIe bridge 111A. Once the BDF identifier is mapped to the unique device address, information may flow between the first and second devices 102 and 104 without managing the information exchanges or staging buffers.

In some embodiments, the first and second PCIe bridges 111A and 111B may be PCIe chips.

In some embodiments, the first and second devices 102 and 104 may each be part of a fabric node (e.g., a node of the fabric network 112). In some embodiments, the first and second devices 102 and 104 may each be a fabric node.

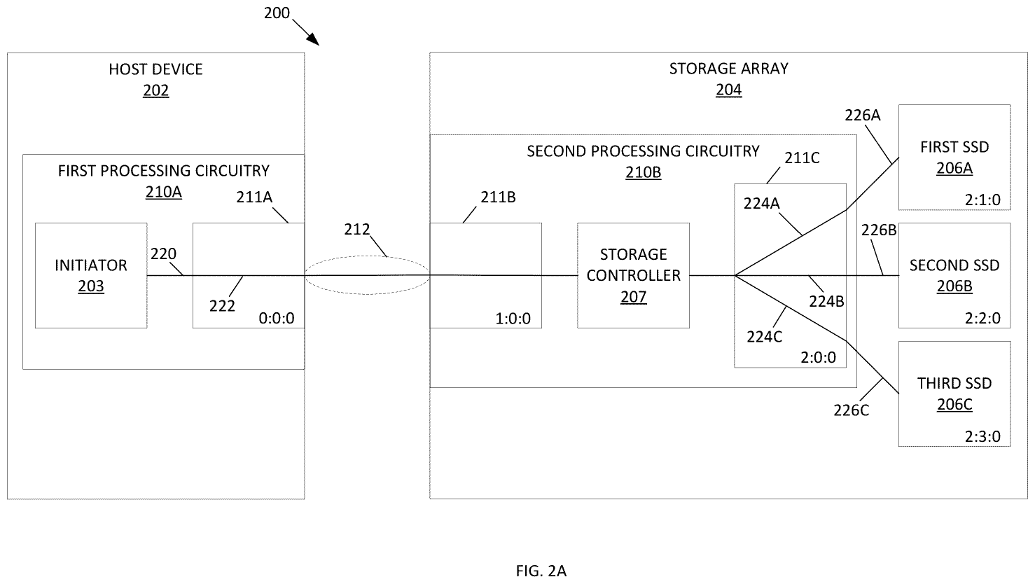

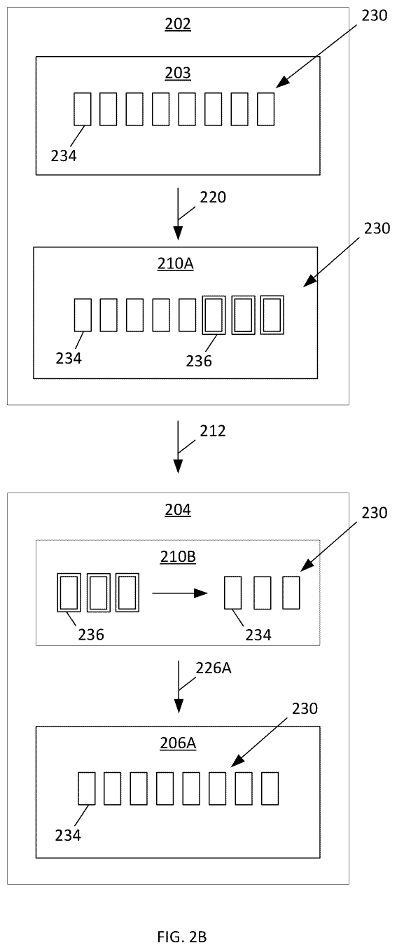

In some embodiments, the first device 102 may be a host device and the second device 104 may be a storage device. In some embodiments, the first device 102 may be a first host device and the second device 104 may be a second host device. The first and second processing circuitry 110A and 110B may allow communication between the host devices over the fabric network 112. In such embodiments, the target 105 may be an initiator 105 of the second device 104. The initiators 103 and 105 may result in conflicting BDF identifiers (e.g., both may be associated with 0:0:0, such as through the first and second processing circuitry 110A and 110B) that may be resolved as discussed in relation to FIG. 2A. In one example, the BDF identifier of the first processing circuitry 110A may be translated to 1:0:0 and the BDF identifier of the second processing circuitry 110B may be translated to 2:0:0.

FIG. 2A shows an illustrative diagram of a system 200 for communicating information (e.g., information 230 in FIG. 2B) between devices, including a subsystem of devices, over a fabric network 212, in accordance with some embodiments of the present disclosure. In particular, the system 200 of FIG. 2A may communicate information between a first device (e.g., a host device 202) and the subsystem of devices (e.g., a storage array 204). The storage array 204 includes a second device (e.g., a first SSD 206A), third device (e.g., a second SSD 206B), and fourth device (e.g., a third SSD 206C), which are collectively referred to as the SSDs 206A-C. While three SSD devices (206A, 206B, and 206C) are shown in FIG. 2A, any suitable number SSD devices can be used in some embodiments.

The system 200 includes a first processing circuitry 210A and a second processing circuitry 210B that communicate over the fabric network 212. In the depicted embodiment, the first processing circuitry 210A includes an initiator 203, such as a CPU, and a first PCIe bridge 211A. The second processing circuitry 210B includes a second PCIe bridge 2111B, a storage controller 207, and a third PCIe bridge 211C. The first PCIe bridge 211A receives information from the initiator 203 and communicates the information to the second PCIe bridge 2111B. The second PCIe bridge communicates the information to the third PCIe bridge 211C through the storage controller 207. The storage controller 207 may handle data services for the SSDs 206A-C. The third PCIe bridge 211C communicates the information to the storage array 204, and in particular, with the SSDs 206A-C.

Each of the SSDs 206A-C may have a BDF identifier and may communicate with each other using the BDF identifier. The initiator 203 may connect to the first PCIe bridge 211A through a first PCIe bus 220. The first SSD 206A, second SSD 206B, and third SSD 206C may connect to the second processing circuitry 210B, and in particular to the third PCIe bridge 211C, through a second PCIe bus 226A, third PCIe bus 226B, and fourth PCIe bus 226C, respectively. The first processing circuitry 210A maps the first PCIe bus 220 to a first unique device address 222, which is associated with the host device 202. The second processing circuitry 210B maps the second PCIe bus 226A, third PCIe bus 226B, and fourth PCIe bus 226C to a second unique device address 224A, third unique device address 224B, and fourth unique device address 224C, respectively. The second, third, and fourth unique device addresses 224A, 224B, and 224C are associated with the first, second, and third SSDs 206A, 206B, and 206C, respectively. The unique device addresses 222 and 224A-C may be used to communicate and route the information over the fabric network 212. The fabric network 212 may be any fabric network, such as Ethernet, FC, or InfiniBand, to name a few examples.

The initiator 203 may discover devices capable of having a BDF identifier. When the system 200 initializes, the initiator 203 may probe a hierarchy of all devices connected to the system 200 and discover the first processing circuitry 210A, which includes a first PCIe bridge device 211A that provides a path to a subset of the hierarchy. The initiator 203 configures the first processing circuitry 210A as a bridge and assigns it a bus number of the BDF identifier. Each device connected to the system 200 may have a PCIe interface (e.g., a PCIe bridge or PCIe chip) that responds to the probe inquiry and identifies downstream devices connected to the PCIe interface. For example, the host device 202 may have a PCIe chip as a root complex. The initiator 203 may initialize the PCIe chip of the host device 202 and enumerate it with a BDF of 0:0:0, where the first “0” is a bus number of the BDF identifier. Downstream devices connected to the PCIe chip of the host device 202 may be enumerated with different device and function numbers, but will have the same bus number (i.e., 0). A type of downstream device may be another bridge that is assigned another bus number that has devices connected to it. The enumeration continues through the hierarchy of downstream devices. For example, the second PCIe bridge 211B may be assigned a BDF of 1:0:0 and the third PCIe bridge 211C may be assigned a BDF of 2:0:0. The first, second, and third SSDs 206A, 206B, and 206C may be assigned a BDF of 2:1:0, 2:2:0, and 2:3:0, respectively.

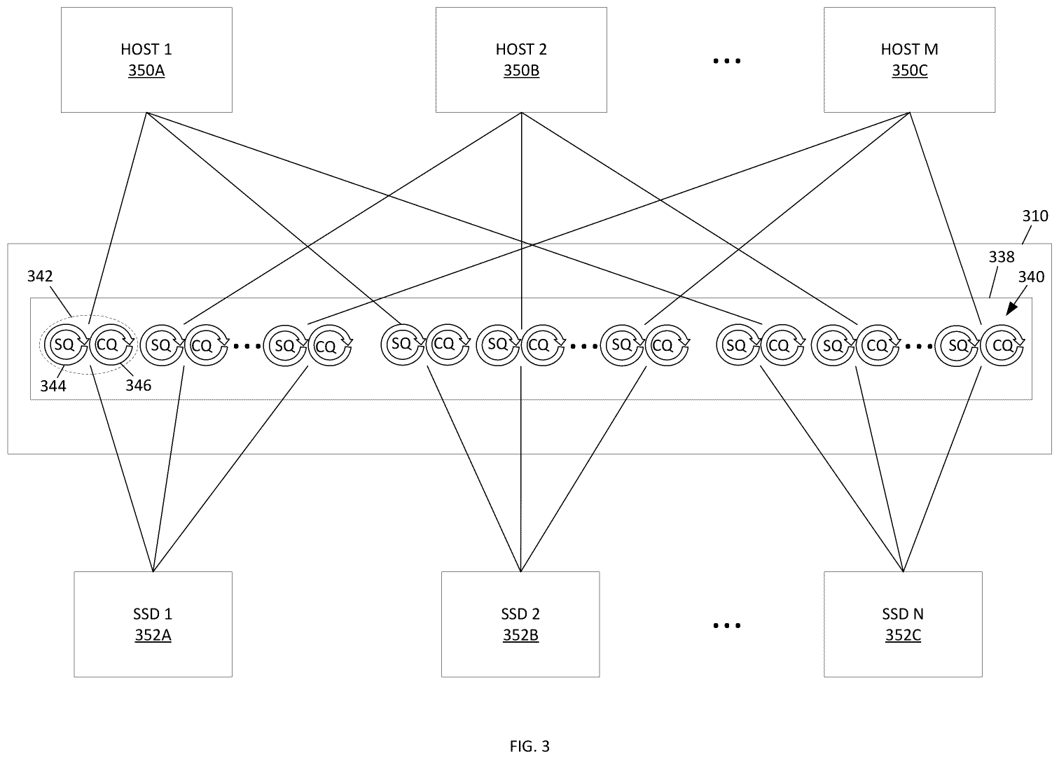

The initiator 203 probes to identify other PCIe chips of other devices. Each PCIe chip is enumerated with a different bus number (e.g., 1, 2, and so forth) and downstream devices are enumerated with different device and function numbers associated with the bus number of the PCIe chip. The initiator 203 may probe through the fabric network 212 to identify devices connected through the fabric network 212 (e.g., the PCIe bridges 211B and 211C and the SSDs 206A-C). Each PCIe chip connected to the fabric network 212 may have an independent peripheral component interconnect (PCI) domain and may be enumerated by the initiator 203 with varying bus numbers. The bus numbers may conflict, such as when there are multiple host devices 202 (e.g., host devices 350A-C in FIG. 3) having independent domains. In a PCIe network, independent PCI domains may be addressed using a non-transparent bridge (NTB), which may be used to interconnect the independent PCI domains. The NTB may perform BDF translation to accommodate conflicting bus numbers between the domains. In some embodiments, the first and second processing circuitry 210A and 210B may be an NTB that performs the BDF translation. In some embodiments, one of both of the first and second processing circuitry 210A and 210B may be a PCIe over fabrics (PCIeoF) bridge. In some embodiments, PCIeoF bridges of independent PCI domains may need to communicate between themselves to resolve address translation. In some embodiments, a multi-cast address may be used that every device recognizes, allowing the fabric network 212 to deterministically find participating devices. The multi-cast address may be used with an Ethernet fabric network 212. In some embodiments, each node of the fabric network 212 may register with a “name server.” A designator may be added to the name server to ensure every device is recognized. Name servers may be used with FC fabric networks 212. Ethernet and InfiniBand fabric networks 212 may use a similar approach to the name server.

The first and second processing circuitry 210A and 210B may each include a bridge chip. The bridge chips may be used to convert or translate between the BDF identifier and the unique device address. The bridge chips may be used to encapsulate and decapsulate the plurality of packets 234.

In some embodiments, the second processing circuitry 210B may be used to discover devices having a BDF identifier.

In some embodiments, the unique device address is a media access control (MAC) address. In some embodiments, the BDF identifiers are mapped to the MAC address. In one embodiment, the BDF identifier is used as a lower three bytes of the MAC address. MAC addresses may be used by Ethernet fabric networks 212.

In some embodiments, the unique device address is an IP address. In some embodiments, the BDF identifiers are mapped to the IP address. In one embodiment, the BDF identifier is used as three bytes of the IP address. IP addresses may be used by Ethernet and InfiniBand fabric networks 212.

In some embodiments, the unique device address is a 24-bit FC identifier. In some embodiments, the BDF identifiers are mapped to the 24-bit FC identifier. In one embodiment, the BDF identifier is used as the 24-bit FC identifier. FC identifiers may be used by FC fabric networks 212.

In some embodiments, the unique device address is a local identifier (LID). In some embodiments, the BDF identifiers are mapped to the LID. In one embodiment, the BDF identifier is used as the LID. LIDs may be used by InfiniBand fabric networks 212.

Although the first PCIe bus 220, first unique device address 222, a line shown through the fabric network 212, second through fourth unique device addresses 224A-C, and second through fourth PCIe bus 226A-C connections are each shown as a single line in the depicted embodiment, the connections may each include multiple lines or lanes. In some embodiments, the first PCIe bus 220, first unique device address 222, and connection through the fabric network 212 may include a line for each endpoint connected to the host device 202 (e.g., the SSDs 206A-C). In some embodiments, a number of lines per each connection may depend on an amount of lanes of a PCIe slot of the host device 202 or SSDs 206A-C. For example, there may be a line for each lane.

FIG. 2B shows an illustrative diagram of a plurality of packets 234 communicated between devices of FIG. 2A, in accordance with some embodiments of the present disclosure. In the embodiment depicted in FIG. 2B, the host device 202 sends information 230 to the first SSD 206A. The information 230 may include data, headers, and the PCIe TLP or data link layer packets (DLLP), to name a few examples.

The initiator 203 communicates the information 230 using the BDF identifier of the first SSD 206A. In the depicted embodiment, the information 230 includes the plurality of packets 234. The initiator 203 sends the information 230 to the first processing circuitry 210A through the first PCIe bus 220. The first processing circuitry 210A encapsulates each of the plurality of packets 234 to generate a plurality of encapsulated packets 236. The first processing circuitry 210A sends each of the plurality of encapsulated packets 236 over the fabric network 212 to the second processing circuitry 210B using the unique device address of the second processing circuitry 210B (e.g., the second unique device address 224A in FIG. 2A). The second processing circuitry 210B decapsulates each of the plurality of encapsulated packets 236 to generate the plurality of packets 234. The second processing circuitry 210B sends the plurality of packets 234 to the first SSD 206A through the second PCIe bus 226A. In some embodiments, the first SSD 206A may decapsulate each of the plurality of encapsulated packets 236 instead of the second processing circuitry 210B.

In some embodiments, each of the plurality of packets is 2 kilobyte (KB) or less, such as 1.5 KB or less, such as 1 KB or less. An Ethernet fabric network 212 may have frames that can accommodate up to 1.5 KB bytes of payload. In some embodiments, the Ethernet may use jumbo frames, which can accommodate up to 9 KB bytes of payload. An FC fabric network 212 may accommodate up to 2 KB bytes of payload. An InfiniBand fabric network 212 may accommodate up to 4 KB bytes of payload.

In some embodiments, the plurality of packets 234 may be PCIe packets. In some embodiments, the plurality of packets 234 may be encapsulated as a plurality of packets of TCP/IP/Ethernet (TIE) packets. In some embodiments, the plurality of packets 234 may be encapsulated as a plurality of packets of a user datagram protocol (UDP)/IP/Ethernet (UIE) packets. The TIE and UIE packets may be used with an Ethernet fabric network 212. UIE packets are well suited due to their lack of state information, such as acknowledgement and checksums. In some embodiments, the plurality of packets 234 may be encapsulated as a plurality of packets of FC packets. The FC packets may be used with a FC fabric network 212. The FC packets may be class 1, 2, or 3 packets. FC class 3 packets are well suited due to their lack of state information, such as acknowledgements and checksums. In some embodiments, the plurality of packets 234 may be encapsulated as a plurality of packets of InfiniBand packets. The InfiniBand packets may be used with an InfiniBand fabric network 212.

In stateless communication embodiments, the notion of a plurality of packets can be dispensed and each individual packet within the plurality of packets can be considered as an atomic unit of communication across the fabric network 212.

In some embodiments, the information 230 may be sent between the host device 202 and other devices, such as the second SSD 206B and/or third SSD 206C. In some embodiments, the other devices may not be SSDs. For example, the host device 202 may communicate with central processing units (CPUs), data processing units (DPUs), graphics cards and graphics processing units (GPUs), field-programmable gate arrays (FPGAs), application-specific integrated circuits (ASICs), sound cards, Ethernet cards, and redundant array of inexpensive disks (RAID) cards to name a few examples. In such embodiments, the second processing circuitry 210B may connect to or reside in the other device.

Although the discussion in relation to FIG. 2B contemplates sending information 230 from the host device 202 to the first SSD 206A using the first and second processing circuitry 210A and 210B, in some embodiments the process may be reversed. The first SSD device 206A may send information 230 to the host device 202. The second processing circuitry 210B may generate the plurality of packets 234 and the plurality of encapsulated packets 236. The second processing circuitry 210B may send the encapsulated packets 236 to the first processing circuitry 210A. The first processing circuitry may decapsulate the encapsulated packets 236 to generate the plurality of packets 234 before sending to the host device 202.

In some embodiments, the processing circuitry 210A and 210B each have a chip, such as a bridge chip, to facilitate communication across the fabric network 212. The bridge chips may be used to encapsulate and decapsulate the plurality of packets 234. The bridge chips may convert or translate between the BDF identifier and the unique device address. For example, the bridge chips may perform the conversion after receiving the plurality of packets 234 from the PCIe bus 220 or 226A and before communicating the encapsulated packets 236 over the fabric network 212, or after receiving the encapsulated packets 236 from the fabric network 212 and before sending the plurality of packets 234 to the PCIe bus 220 or 226A.

FIG. 3 shows an illustrative diagram of information (e.g., information 230 in FIG. 2B) communicated between devices using input/output (I/O) queues 340, in accordance with some embodiments of the present disclosure. The devices may include host devices (e.g., a first host 350A, a second host 350B, and so forth up to an “mth” host 350C) and storage devices (e.g., a first SSD 352A, a second SSD 352B, and so forth up to an “nth” SSD 352C).

The I/O queues 340 reside in a memory 338 of a processing circuitry 310, which may be similar to the second processing circuitry 210B discussed in relation to FIGS. 2A and 2B. The I/O queues 340 include a plurality of queue pairs 342. Each queue pair 342 of the queue pairs 342 includes a submission queue (SQ) 344 and a completion queue (CQ) 346. Each of the host devices 350A-C and storage devices 352A-C are bound to queue pairs 342. The I/O queues 340 may be assigned to the storage devices 352A-C using an “admin” command from the host devices 350A-C. The processing circuitry 310 may respond to the admin command from the host devices 350A-C to complete creation of the I/O queues 340 by providing a local 64-bit PCIe address of each I/O queue 340. In the depicted embodiment, each of the storage devices 352A-C has an amount of queue pairs 342 equal to an amount of host devices 350A-C, which is “m” hosts. The amount of queue pairs 342 allows each of the host devices 350A-C to communicate with each of the storage devices 350A-C. Once the I/O queues 340 are established, information may flow between the host and storage devices without requiring CPU bandwidth from the host and storage devices to manage information exchanges or staging buffers.

The “1/O queues” 340 is an NVMe construct, and not a PCIe construct. I/O queues are used to submit and complete NVMe commands. NVMe commands describe the information to be transferred for the command, including length and location of the information. When a host writes a command into an I/O queue across the fabric, it is done so by transmitting and receiving a plurality of PCIe packets. In the present invention, these PCIe packets are addressed, encapsulated, transmitted, received, decapsulated, and forwarded onto a destination PCIe bus, just as any other packet.

The first host 350A may communicate with the first SSD 352A by writing a command as an entry to the SQ 344 (referred to as SQ entry). The command describes the information to be transferred between the first host 350A and the first SSD 352A. As discussed in FIG. 2B, the information 230 may be sent in packets (e.g., packets 234 or encapsulated packets 236). The first SSD 352A fetches a command from SQ 344 and initiates information transfer requests to send or receive the information 230. When all information 230 is transferred, the first SSD 352A writes an entry to the CQ 346 (referred to as CQ entry) to indicate the command associated with the SQ entry has completed and the information has been transferred. The first host 350A processes the CQ entry. The host may also write to a doorbell register (not shown) to signal a new command has been written to the SQ 344. The first SSD 352A may write a doorbell register to signal the CQ entry, such as after the information 230 has been transferred.

Each queue of the I/O queues 340 has a queue identifier. The queue identifier of each SQ 344 is not explicitly specified in the NVMe command. The queue identifier of each SQ 344 may be inferred from the SQ 344 the queue identifier is populated in. Doorbell registers may be accessed via PCIe addresses and an associated SQ identifier of the doorbell registers may be inferred. The SQ identifiers may be virtualized, exposing one value to the first host 350A, and a potentially different value to the first SSD 352A. The CQ 346 has a queue identifier. The processing circuitry 310 may intercept I/O command completions and alter the CQ identifier before passing the altered CQ identifier along to the first host 350A. The CQ identifiers for an “abort” process and a “get error log” command may be exceptions to the CQ alteration because the SQ identifier for each of these is explicitly specified and must be properly mapped before it is sent to the first host 350A.

Although communication is discussed between the first host 350A and the first SSD 352A, the communication described above may occur between any of the host devices 350A-C and the storage devices 350A-C.

In some embodiments, there are more storage devices 352A-C than host devices (i.e., n>m) or vice versa (i.e., n<m). In some embodiments, there are a same amount of storage devices 352A-C and host devices 350A-C (i.e., n=m). In some embodiments, the amount of queue pairs 342 may not be based on a total amount of host devices 350A-C. For example, some storage devices 352A-C may not be connected to all of the host devices 350A-C.

In some embodiments, the processing circuitry 310 may be similar to the processing circuitry 110 discussed in relation to FIG. 1. In some embodiments, the processing circuitry 310 may be similar to the first processing circuitry 210A discussed in relation to FIGS. 2A and 2B. In some embodiments, the processing circuitry 310 may be similar to the first and second processing circuitry 210A and 210B discussed in relation to FIGS. 2A and 2B. In some embodiments, the processing circuitry 310 may be similar to a storage control subsystem such as discussed in relation to FIG. 2A.

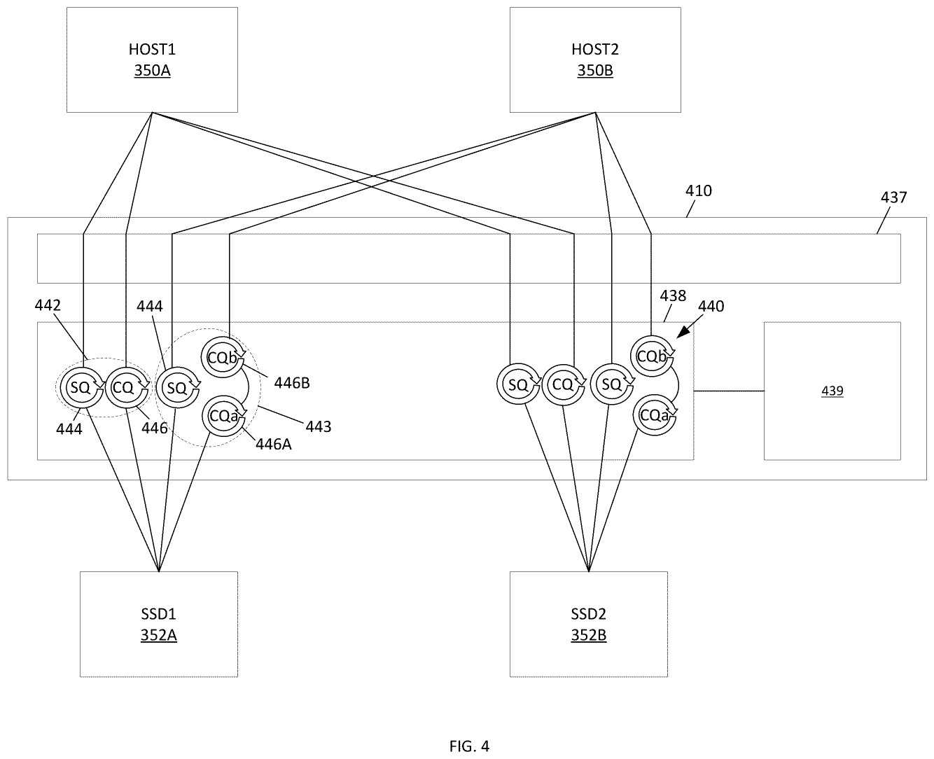

FIG. 4 shows an alternate illustrative diagram of information (e.g., information 230 in FIG. 2B) communicated between devices using I/O queues 440, in accordance with some embodiments of the present disclosure. The devices may include the first host 350A and the second host 350B (collectively referred to as host devices 350A and 350B) and the first SSD 352A and the second SSD 352B (collectively referred to as storage devices 352A and 352B).

A processing circuitry 410 includes a bridge chip 437, a memory 438, and a circuitry logic 439. The circuitry logic 429 may include a controller, a central processing unit (CPU) 439, or code, to name a few examples. The circuitry logic 439 may discover the first and second SSDs 352A and 352B and set up the I/O queues 440. The I/O queues 440 reside in the memory 438 and include an I/O queue pair 442 and an I/O queue group 443.

The I/O queue pair 442 includes an SQ 444 and a CQ 446. The I/O queue group 443 includes the SQ 444, a first CQ 466A, and a second CQ 466B. The I/O queues 440 function similar to the I/O queues 340 discussed in relation to FIG. 3, except as noted. The first CQ 466A is specific to a storage device (e.g., the first SSD 352A or the second SSD 352B) and the second CQ 466B is specific to a corresponding host device (e.g., the first host 350A or the second host 350B). In one example, the first SSD 352A writes an entry to the first CQ 446A (referred to as a storage device CQ entry). The CPU 439 processes and translates the storage device CQ entry and moves the entry to the second CQ 446B (referred to as a host device CQ entry). The first host 350A processes the host device CQ entry. The host devices 350A and 350B may use a doorbell register as discussed in relation to FIG. 3. The first SSD 352A and second SSD 352B may use a doorbell register as discussed in relation to FIG. 3.

In some embodiments, the processing circuitry 410 may be part of or attached to a storage system, such as the storage array 204 discussed in relation to FIG. 2A. The first and second CQs 446A and 446B may be needed for embodiments having processing circuitry 410 part of or attached to host devices and storage devices, such as the first and second processing circuitry 210A and 210B discussed in relation to FIG. 2A. For example, the first CQ 446A may identify the host devices 350A and 350B using different BDF identifiers than the second CQ 446B and the second CQ 446B may identify the storage devices 352A and 352B using different BDF identifiers than the first CQ 446A. In such embodiments, the circuitry 439 may translate the BDF identifiers.

In some embodiments, storage device CQ translation may be offloaded to a field-programmable gate array (FPGA) or application-specific integrated circuit (ASIC) logic, where duplicate CQs 466A and 466B may not be needed or may be translated without CPU intervention.

Although FIG. 4 shows two host devices 350A and 350B and two storage devices 352A and 352B, other embodiments may use more or less host and storage devices.

Although FIGS. 3 and 4 discuss communication between the host devices 350A and 350B and the storage devices 352A and 352B, in some embodiments, the communication make take place between the host devices 350A and 350B. For example, between a CPU and any of a CPU, DPU, graphics card or GPU, FPGA, ASIC, and sound cards, to name a few examples. In such embodiments, the I/O queues 340 or 440 may be part of or attached to the host devices 350A and 350B.

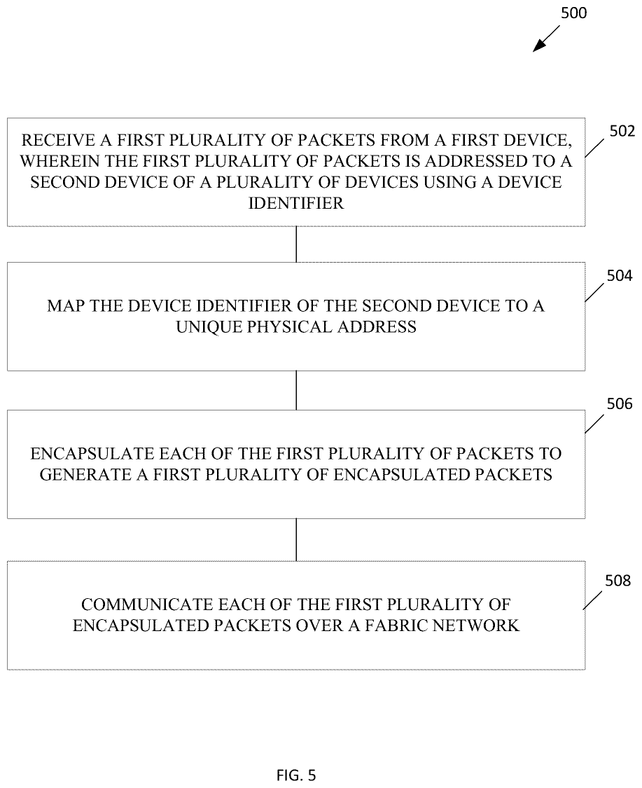

FIG. 5 illustrates a method 500 for communicating information (e.g., information 230 in FIG. 2B) over a fabric network, in accordance with some embodiments of this disclosure.

The method 500 begins at operation 502 with a processing circuitry (e.g., the processing circuitry 110, 210A and/or 210B, 310, or 410 in FIGS. 1, 2A and 2B, 3, and 4, respectively) receiving a plurality of packets from a first device (e.g., the first device 102 in FIG. 1, host device 202 in FIGS. 2A and 2B, and host devices 350A-C in FIGS. 3 and 4), as described above with respect to FIGS. 1-4. In some embodiments of method 500, the plurality of packets is addressed to a second device (e.g., the second through fourth device 106A-C in FIG. 1, first through third SSD 206A-C in FIGS. 2A and 2B, and storage devices 352A-C in FIGS. 3 and 4) of a plurality of devices using a device identifier.

At operation 504, the processing circuitry maps the device identifier of the second device to a unique device address, as described above with respect to FIGS. 1-2B.

At operation 506, the processing circuitry encapsulates each of the plurality of packets to generate a plurality of encapsulated packets (e.g., the encapsulated packets 236 in FIG. 2B), as described above with respect to FIGS. 2B and 3.

At operation 508, the processing circuitry communicates each of the plurality of encapsulated packets over a fabric network, as described above with respect to FIGS. 2B-4. In some embodiments of method 500, the unique device address of the second device is used to route the plurality of encapsulated packets to the second device.

In some embodiments, the device identifier of the second device is a bus:device:function identifier. In some embodiments, the first device is a host device, and the second device is a storage device. In some embodiments, the second device is a just a bunch of flash (JBOF) device. In some embodiments, the first device is a storage device and the second device is a host device.

Some embodiments further include receiving information from the second device. The information is addressed to the first device using a device identifier. Some embodiments further include mapping the device identifier of the first device to a unique device address. Some embodiments further include generating a plurality of packets from the information and encapsulating each of the plurality of packets to generate a plurality of encapsulated packets. Some embodiments further include communicating each of the plurality of encapsulated packets over the fabric network. The unique device address of the first device is used to route the plurality of encapsulated packets to the first device.

In some embodiments, the first and second devices are configured to use peripheral component interconnect express (PCIe) bus interface for sending and receiving information.

Some embodiments further include establishing an input/output (I/O) queue pair (e.g., the queue pair 342 and 442 in FIGS. 3 and 4, or in some embodiments, the queue group in FIG. 4) and mapping the I/O queue pair to the first device and to the second device.

In some embodiments, communicating each of the plurality of encapsulated packets over the fabric network is initiated by sending a command that describes the information to the I/O queue pair.

In some embodiments, the plurality of packets are PCIe) packets. Each of the plurality of packets are encapsulated as a plurality of packets of UDP/IP/Ethernet (UIE) packets.

In some embodiments, the plurality of packets are PCIe packets. Each of the plurality of packets are encapsulated as a plurality of packets of TCP/IP/Ethernet (TIE) packets.

In some embodiments, the plurality of packets are PCIe packets. Each of the plurality of packets are encapsulated as a plurality of packets of Fibre Channel (FC) packets.

In some embodiments, the plurality of packets are PCIe packets. Each of the plurality of packets are encapsulated as a plurality of packets of InfiniBand packets.

In some embodiments, the each of the plurality of packets is 2 kilobyte (KB) or less.

In some embodiments, the unique device address is a media access control (MAC) address. Mapping the device identifier of the second device to a unique device address comprises mapping the device identifier of the second device to the MAC address by using the device identifier as a lower three bytes of the MAC address.

In some embodiments, the unique device address is an internet protocol (IP) address. Mapping the device identifier of the second device to a unique device address comprises mapping the device identifier of the second device to the IP address by using the device identifier as three bytes of the IP address.

In some embodiments, the unique device address is a 24-bit Fibre Channel (FC) identifier. Mapping the device identifier of the second device to a unique device address comprises mapping the device identifier of the second device to the 24-bit FC identifier by using the device identifier as the 24-bit FC identifier.

In some embodiments, the unique device address is a local identifier (LID). Mapping the device identifier of the second device to a unique device address comprises mapping the device identifier of the second device to the LID by using the device identifier the LID address.

Note that FIG. 5 is just one example of a method, and other methods including fewer, additional, or alternative steps are possible consistent with this disclosure.

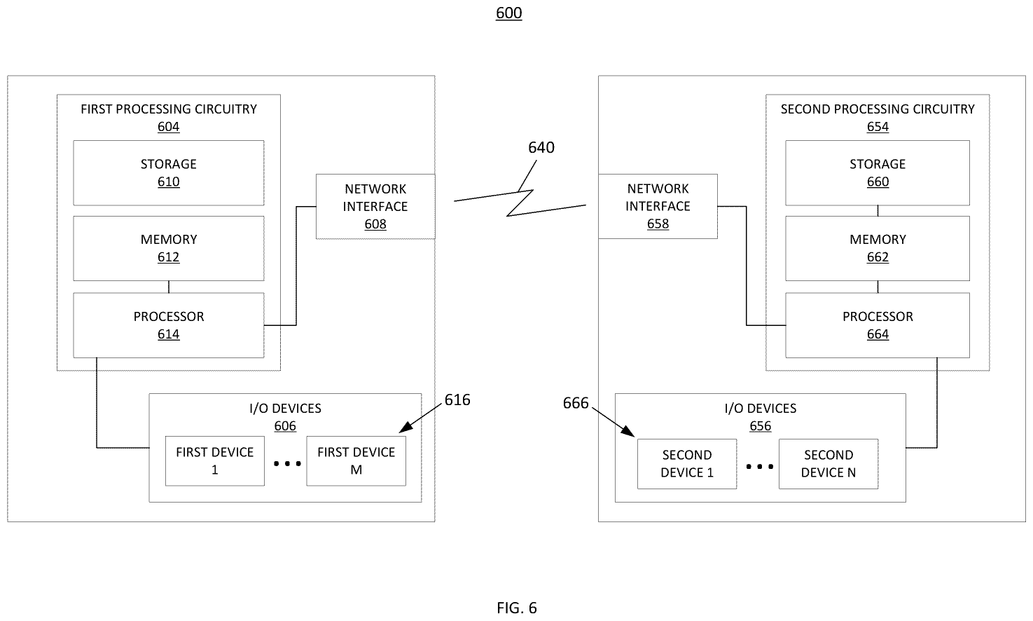

FIG. 6 shows an example of system processing circuitry 600, in accordance with some embodiments of the present disclosure.

The system processing circuitry 600 includes a first processing circuitry 604 and a second processing circuitry 654. The first processing circuitry 604 connects to I/O devices 606 and a network interface 608. The first processing circuitry 604 includes a storage 610, a memory 612, and a controller, such as a CPU 614. The CPU 614 may include any of the storage controller 207 discussed in relation to FIG. 2A and the circuitry logic 429 discussed in relation to FIG. 4. The CPU 614 is configured to process computer-executable instructions, e.g., stored in the memory 612 or storage 610, and to cause the system processing circuitry 600 to perform methods and processes as described herein, for example with respect to FIG. 5.

The CPU 614 is included to be representative of a single CPU, multiple CPUs, a single CPU having multiple processing cores, and other forms of processing architecture capable of executing computer-executable instructions.

The I/O devices 606 include first devices 616, which may include any of the first device 102 discussed in relation to FIG. 1, the host device 202 discussed in FIGS. 2A and 2B, and the host devices 350A-C discussed in relation to FIGS. 3 and 4.

The network interface 608 provides the first processing circuitry 604 with access to external networks, such as a fabric network 640. The bridge chip 437 discussed in relation to FIG. 4 may include the network interface 608. The fabric network 640 may include the fabric network 212 discussed in relation to FIGS. 2A and 2B. In some implementations, network interface 608 may include one or more of a receiver, a transmitter, or a transceiver.

The fabric network 640 may be a storage area network (SAN), a local area network (LAN), a wide area network (WAN), the Internet, a cellular network, a satellite communication network, and the like and communicate according to Ethernet, FC, or InfiniBand protocols, to name a few examples.

The second processing circuitry 654 connects to I/O devices 656 and a network interface 658. The second processing circuitry 654 includes a storage 660, a memory 662, and a processor, such as a CPU 664. The CPU 664 and network interface 658 may be configured similar to the CPU 614 and network interface 608, respectively.

The I/O devices 656 include second devices 656, which may include any of the second through fourth devices 106A-C discussed in relation to FIG. 1, the SSDs 206A-C discussed in FIGS. 2A and 2B, and the storage devices 352A-C discussed in relation to FIGS. 3 and 4.

The network interface 658 connects the second processing circuitry 654 to the first processing circuitry 604 through the fabric network 640, allowing the first and second devices 616 and 666 to communicate.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for communication, comprising:
receiving a first plurality of packets from a first device, wherein the first plurality of packets is addressed to a second device of a plurality of devices using a device identifier;
mapping the device identifier of the second device to a unique device address;
encapsulating each of the plurality of packets to generate a first plurality of encapsulated packets; and
communicating each of the first plurality of encapsulated packets over a fabric network, wherein the unique device address of the second device is used to route the first plurality of encapsulated packets to the second device.

2. The method of claim 1, wherein the device identifier of the second device is a bus:device:function identifier, the first device is a host device, and the second device is a storage device.

3. The method of claim 2, wherein the second device is a just a bunch of flash (JBOF) device.

4. The method of claim 1, wherein the device identifier of the second device is a bus:device:function identifier, the first device is a storage device, and the second device is a host device.

5. The method of claim 1, further comprising:
receiving a second plurality of packets from the second device, wherein the second plurality of packets is addressed to the first device using a device identifier;
mapping the device identifier of the first device to a unique device address of the first device;
encapsulating each of the second plurality of packets received from the second device to generate a second plurality of encapsulated packets; and
communicating each of the second plurality of encapsulated packets over the fabric network, wherein the unique device address of the first device is used to route the second plurality of encapsulated packets to the first device.

6. The method of claim 1, wherein:
the device identifier of the second device is a bus:device:function identifier; and
the first and second devices are configured to use peripheral component interconnect express (PCIe) bus interface for sending and receiving information.

7. The method of claim 1, wherein each of the first plurality of encapsulated packets are communicated statelessly over the fabric network.

8. The method of claim 1, further comprising:
establishing input/output (I/O) queues; and
mapping the I/O queues to the first device and to the second device.

9. The method of claim 8, wherein communicating each of the first plurality of encapsulated packets over the fabric network is initiated by writing a command to the I/O queue, and comprises sending the first plurality of encapsulated packets to the second device.

10. The method of claim 1, wherein:
the device identifier of the second device is a bus:device:function identifier;
the first plurality of packets are peripheral component interconnect express (PCIe) packets; and
each of the first plurality of packets are encapsulated as a plurality of packets of TCP/IP/Ethernet (TIE) packets.

11. The method of claim 1, wherein:
the device identifier of the second device is a bus:device:function identifier;
the first plurality of packets are peripheral component interconnect express (PCIe) packets; and
each of the first plurality of packets are encapsulated as a plurality of packets of UDP/IP/Ethernet (UIE) packets.

12. The method of claim 1, wherein:
the device identifier of the second device is a bus:device:function identifier:
the first plurality of packets are peripheral component interconnect express (PCIe) packets; and
each of the first plurality of packets are encapsulated as a plurality of packets of Fibre Channel (FC) packets.

13. The method of claim 1, wherein:
the device identifier of the second device is a bus:device:function identifier;
the first plurality of packets are peripheral component interconnect express (PCIe) packets; and
each of the first plurality of packets are encapsulated as a plurality of packets of InfiniBand packets.

14. The method of claim 1, wherein each of the first plurality of packets is 2 kilobytes (KB) or less.

15. The method of claim 1, wherein:
the unique device address is a media access control (MAC) address; and
mapping the device identifier of the second device to the unique device address comprises mapping the device identifier of the second device to the MAC address by using the device identifier as a lower three bytes of the MAC address.

16. The method of claim 1, wherein:
the unique device address is an internet protocol (IP) address; and
mapping the device identifier of the second device to the unique device address comprises mapping the device identifier of the second device to the IP address by using the device identifier as three bytes of the IP address.

17. The method of claim 1, wherein:
the unique device address is a 24-bit Fibre Channel (FC) identifier; and
mapping the device identifier of the second device to the unique device address comprises mapping the device identifier of the second device to the 24-bit FC identifier by using the device identifier as the 24-bit FC identifier.

18. The method of claim 1, wherein:
the unique device address is a local identifier (LID); and
mapping the device identifier of the second device to the unique device address comprises mapping the device identifier of the second device to the LID by using the device identifier as the LID address.

19. A system comprising processing circuitry configured to perform a method, the method comprising:
receiving information from a first device, wherein the information is addressed to a second device of a plurality of devices using a device identifier;
mapping the BDF identifier of the second device to a unique device address;
generating a plurality of packets from the information;
encapsulating each of the plurality of packets to generate a plurality of encapsulated packets; and
communicating each of the plurality of encapsulated packets over a fabric network, wherein the unique device address of the second device is used to route the plurality of encapsulated packets to the second device.

20. A non-transitory computer-readable storage medium comprising computer-executable instructions that, when executed by a processor, cause the processor to perform operations comprising:
receiving information from a first device, wherein the information is addressed to a second device of a plurality of devices using a device identifier;
mapping the BDF identifier of the second device to a unique device address;
generating a plurality of packets from the information;
encapsulating each of the plurality of packets to generate a plurality of encapsulated packets; and
communicating each of the plurality of encapsulated packets over a fabric network, wherein the unique device address of the second device is used to route the plurality of encapsulated packets to the second device.
